(19) United States
(12) Patent Application Publication
(10) Pub. No.: US 2022/0306058 A1
(43) Pub. Date: Sep. 29, 2022

(54) BRAKING METHOD FOR VEHICLE, ELECTRONIC DEVICE AND STORAGE MEDIUM

(71) Applicant: APOLLO INTELLIGENT CONNECTIVITY (BEIJING) TECHNOLOGY CO., LTD., Beijing (CN)

(72) Inventors: Liang XING, BEIJING (CN); Shuqing SONG, BEIJING (CN); Wentao YANG, BEIJING (CN); Shuaishuai ZHAO, BEIJING (CN); Qionghua LUO, BEIJING (CN); Lifeng WANG, BEIJING (CN); Yunchan FENG, BEIJING (CN); Tao WANG, BEIJING (CN); Xiaochen CAO, BEIJING (CN); Fuchuang WU, BEIJING (CN); Yi WU, BEIJING (CN)

(21) Appl. No.: 17/842,080

(22) Filed: Jun. 16, 2022

(30) Foreign Application Priority Data
Jun. 18, 2021 (CN) 202110680233.0

(51) Int. Cl. B60T 8/174; B60T 8/171

(52) U.S. Cl. CPC B60T 8/174; B60T 8/171; B60T 2201/03; B60T 2260/00

(57) ABSTRACT

A braking method for a vehicle, an electronic device and a storage medium are provided, and relates to the field of intelligent vehicles. The method includes: generating, in a case where a braking trigger signal is received, a first braking control signal according to a first braking parameter of the vehicle, wherein the first braking control signal is used to control a braking traction mechanism to draw a brake pedal according to the first braking parameter, to perform braking; collecting braking data of a current braking process; evaluating a braking effect of the current braking process according to the collected braking data; and determining whether to adjust the first braking parameter according to a result of the evaluating, wherein the determined first braking parameter is used for a next braking process of the vehicle.

### CROSS-REFERENCE TO RELATED APPLICATION

This application claims priority to Chinese patent application No. 202110680233.0, filed on Jun. 18, 2021, which is hereby incorporated by reference in its entirety.

### TECHNICAL FIELD

The present disclosure relates to the technical field of vehicles, and in particular to the field of intelligent vehicles.

### BACKGROUND

In the current teaching process of a driving school, a coach is usually needed to accompany a student to guide and teach the student. At the same time, the coach can assist the student to brake in time when encountering an emergency.

An intelligent teaching vehicle can replace the coach, and an electronic coach is used to assist the coach and the student in braking.

### SUMMARY

The present disclosure provides a braking method and apparatus for a vehicle, a device, a storage medium, a computer program product, and a vehicle.

According to a first aspect of the present disclosure, a braking method for a vehicle is provided, which includes:

generating, in a case where a braking trigger signal is received, a first braking control signal according to a first braking parameter of the vehicle, wherein the first braking control signal is used to control a braking traction mechanism to draw a brake pedal according to the first braking parameter, to perform braking;

collecting braking data of a current braking process;

evaluating a braking effect of the current braking process according to the collected braking data; and

determining whether to adjust the first braking parameter according to a result of the evaluating, wherein the determined first braking parameter is used for a next braking process of the vehicle.

According to a second aspect of the present disclosure, an electronic device is provided, which includes:

at least one processor; and

a memory communicatively connected with at least one processor;

wherein

the memory stores instructions executable by the at least one processor, and the instructions, when executed by the at least one processor, enable the at least one processor to perform the method provided by any embodiment of the present disclosure.

According to a third aspect of the present disclosure, there is provided a non-transitory computer-readable storage medium storing computer instructions, wherein the computer instructions, when executed by a computer, cause the computer to perform the method provided by any embodiment of the present disclosure.

According to a fourth aspect of the present disclosure, there is provided a vehicle including the electronic device provided by any embodiment of the present disclosure.

It should be understood that the content described in this section is neither intended to limit the key or important features of the embodiments of the present disclosure, nor intended to limit the scope of the present disclosure. Other features of the present disclosure will be readily understood from the following description.

### BRIEF DESCRIPTION OF THE DRAWINGS

The drawings are used to better understand the solution and do not constitute a limitation to the present disclosure, wherein:

FIG. 1 is a flowchart of a braking method for a vehicle according to an embodiment of the present disclosure;

FIG. 2 is a schematic diagram of an application scenario according to an embodiment of the present disclosure;

FIG. 3 is a schematic diagram of an application example according to an embodiment of the present disclosure;

FIG. 4 is a block diagram of a braking apparatus for a vehicle according to an embodiment of the present disclosure;

FIG. 5 is a block diagram of a braking apparatus for a vehicle according to one implementation of an embodiment of the present disclosure; and

FIG. 6 is a block diagram of an electronic device for implementing the method according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

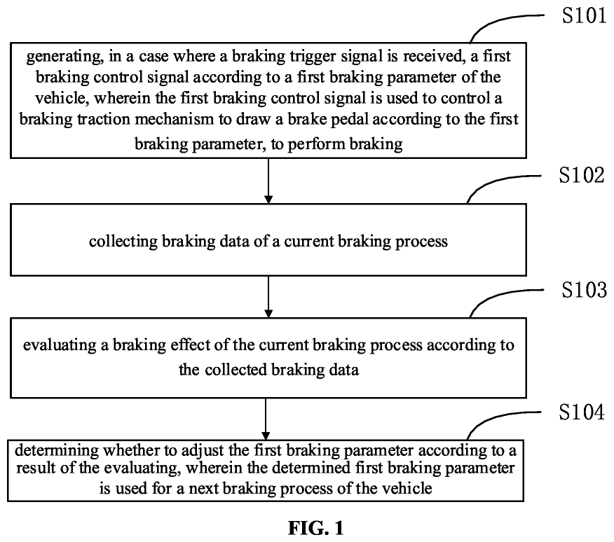

FIG. 1 shows a braking method for a vehicle according to an embodiment of the present disclosure. As shown in FIG. 1, the method includes:

S101, generating, in a case where a braking trigger signal is received, a first braking control signal according to a first braking parameter of the vehicle, wherein the first braking control signal is used to control a braking traction mechanism to draw a brake pedal according to the first braking parameter, to perform braking;

S102, collecting braking data of a current braking process;

S103, evaluating a braking effect of the current braking process according to the collected braking data; and

S104, determining whether to adjust the first braking parameter according to a result of the evaluating, wherein the determined first braking parameter is used for a next braking process of the vehicle.

The method of this embodiment can be applied to an intelligent teaching vehicle in a driving school. The intelligent teaching vehicle can replace a coach, and an electronic coach is used to assist the coach and a student in braking.

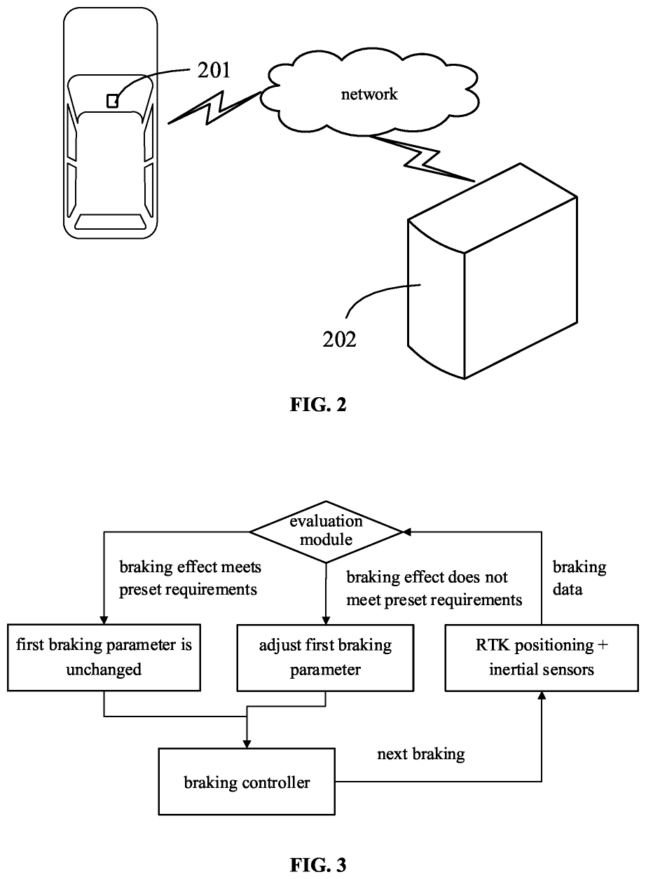

FIG. 2 is a schematic diagram of an application scenario according to an embodiment of the present disclosure. As shown in FIG. 2, a vehicle is equipped with a vehicle-mounted terminal 201, and the vehicle-mounted terminal 201 may be a hardware, for example, an electronic device with a display screen, such as a mobile phone, a tablet, a portable computer, and so on. In a case where the vehicle-mounted terminal 201 is a software or an Application (APP), it can be installed in the above-mentioned electronic device. A server 202 can provide various services, for example, providing support for an application installed on the vehicle-mounted terminal 201. The method provided by the embodiment of the present disclosure can be performed by the server 202 or the vehicle-mounted terminal 201, and an apparatus corresponding to the method can be provided in the vehicle-mounted terminal 201 or the server 202. Herein, any number of vehicle-mounted terminals, networks and servers can be configured in order to meet the needs.

In one example, a positioning device is installed on the vehicle, and a teaching application can acquire the position of the vehicle in real time. In a case where the vehicle reaches a specified position, the teaching application will issue a braking trigger signal.

In another example, a plurality of sensors are installed on the vehicle, to sense obstacles, distances, positions and so on. Based on sensing data of these sensors, a safety protection application can send a braking trigger signal before colliding with an obstacle and in a case of speeding, rolling, or driving out of a prescribed area, etc.

A braking traction mechanism and a braking controller can be provided on the vehicle. In S101, in a case where the braking trigger signal is received, the first braking control signal can be generated according to the current first braking parameter of the vehicle. After receiving the first braking control signal, a braking controller can control a braking traction mechanism to draw a brake pedal in accordance with the current first braking parameter to perform braking, thus completing the current braking process.

Illustratively, the braking traction mechanism includes a braking control motor and a wire rope. The braking control motor drives a connecting spool, upon which the wire rope is wound. The end of the wire rope are fixedly installed on a connecting arm of the brake pedal. The braking control motor controls depression of the brake pedal by tightening the wire rope. After receiving the first braking control signal, the braking controller sends an instruction to the braking control motor, the instruction including the current first braking parameter.

In one implementation, the first braking parameter includes a braking traction absolute value, a braking traction speed and a braking traction acceleration. As such, in the process of braking, the amount of depression, a depression speed, and a depression acceleration of the brake pedal can all be taken into account, thereby improving the user's somatic sensation.

Furthermore, in S102, the braking data can be collected in real time in the current braking process, and used to evaluate the braking effect of the current braking process in S103.

In one implementation, S102 may include: collecting at least one of position data, vehicle speed data, acceleration data or jerk data of the vehicle in the current braking process, so as to provide an evaluation criterion for the braking effect.

Illustratively, the braking data can be collected based on the real-time kinematic (RTK) positioning technology and inertial sensors. The braking data may include position data of the vehicle, vehicle speed data, acceleration data, jerk data, and so on.

In one implementation, S103 may include: determining a braking distance in the current braking process according to the collected position data; determining somatosensory information of the current braking process according to the collected vehicle speed data, acceleration data and jerk data; and evaluating the braking effect according to the braking distance and the somatosensory information.

Illustratively, as shown in FIG. 3, an evaluation module can determine a braking distance based on position data of a vehicle, determine somatosensory information based on vehicle speed data, acceleration data and jerk data, and then evaluate the braking effect by taking the braking distance and the somatosensory information as an evaluation criterion.

Furthermore, in S103, the braking effect of the current braking process can be evaluated according to the collected braking data of the current braking process. In S104, in a case where the result of the evaluating is that the braking effect meets a preset requirement, the current first braking parameter is kept unchanged, that is, the current first braking parameter is saved for use in the next braking process of the vehicle; in a case where the result of the evaluating is that the braking effect does not meet the preset requirement, the current first braking parameter is adjusted, and the adjusted first braking parameter is saved for use in the next braking process of the vehicle. Illustratively, an automatic calibration (adjustment) program according to the embodiment of the present disclosure can be constructed based on a reinforcement learning model.

According to the braking method of the embodiment of the present disclosure, braking characteristics of each vehicle can be calibrated automatically, allowing the application to quickly adapt to each vehicle. Illustratively, in a case where the vehicle is initially used, the first braking parameter can be preset. According to the braking method of this embodiment, braking occurs during use—the braking effect is evaluated—the braking effect does not meet the preset requirement—the first braking parameter is adjusted—next braking occurs—the braking effect is evaluated—the braking effect does not meet the preset requirement—the first braking parameter is adjusted . . . until the braking effect meets the preset requirement, at this time the first braking parameter is saved, that is, the automatic calibration program adapted to the braking characteristics of the vehicle is completed.

Moreover, according to the braking method of the embodiment of the present disclosure, this automatic calibration program will be continuously and automatically adjusted in the subsequent use. Once the braking effect does not meet the preset requirement, the first braking parameter will be adjusted again and the calibration will be cycled, so that the calibration will become more and more accurate and can also adapt to the gradual changes in the braking characteristics of the vehicle after long-term use.

In one implementation, the method of the embodiment of the present disclosure may further include: generating, in a case where the braking trigger signal is received, a second braking control signal according to a second braking parameter of the vehicle, wherein the second braking control signal is used to control a clutch traction mechanism to draw a clutch pedal according to the second braking parameter, to separate an engine of the vehicle from a gearbox of the vehicle.

After receiving the second braking control signal, a clutch controller can control the clutch traction mechanism to draw the clutch pedal in accordance with the current second braking parameter. Illustratively, the clutch traction mechanism includes a clutch control motor and a wire rope. The clutch control motor drives a connecting spool, upon which the wire rope is wound. The end of the wire rope is fixedly installed on a connecting arm of the clutch pedal. The clutch control motor controls depression of the clutch pedal by tightening the wire rope. After receiving the second braking control signal, the clutch controller sends an instruction to the clutch control motor, the instruction including the current second braking parameter.

In one implementation, the second braking parameter includes a clutch traction absolute value, a clutch traction speed and a clutch traction acceleration. As such, in the braking process, the amount of depression, a depression speed and a depression acceleration of the clutch pedal can all be taken into account, thereby improving the user's somatic sensation and better protecting the clutch.

The braking method according to this embodiment includes the operation of the clutch pedal, which, through the cooperation of the clutch and the brake, improves the somatic sensation and can protect the clutch of the vehicle. In addition, the braking method of this embodiment can automatically adjust the braking parameters according to the characteristics of the vehicle and the braking effect, so that the braking effect becomes more and more ideal and more accurate, and the user's somatic sensation can be greatly improved.

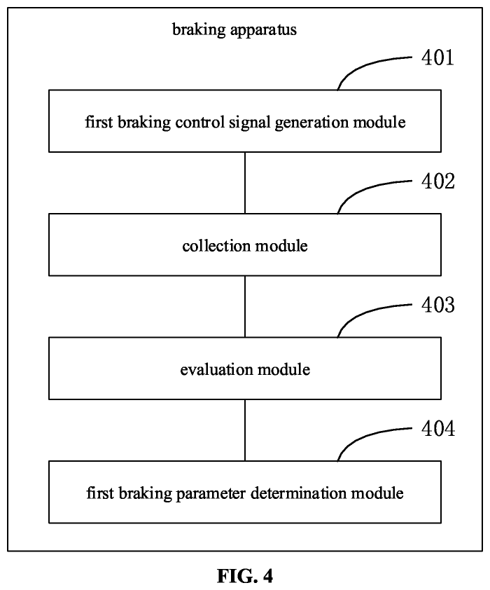

FIG. 4 shows a block diagram of a braking apparatus for a vehicle according to an embodiment of the present disclosure. As shown in FIG. 4, the apparatus includes:

a first braking control signal generation module 401, configured for generating, in a case where a braking trigger signal is received, a first braking control signal according to a first braking parameter of the vehicle, wherein the first braking control signal is used to control a braking traction mechanism to draw a brake pedal according to the first braking parameter, to perform braking;

a collection module 402, configured for collecting braking data of a current braking process;

an evaluation module 403, configured for evaluating a braking effect of the current braking process according to the collected braking data; and

a first braking parameter determination module 404, configured for determining whether to adjust the first braking parameter according to a result of the evaluating, and the determined first braking parameter is used for a next braking process of the vehicle.

In one implementation, the collection module 402 is further configured for collecting at least one of position data, vehicle speed data, acceleration data or jerk data of the vehicle in the current braking process.

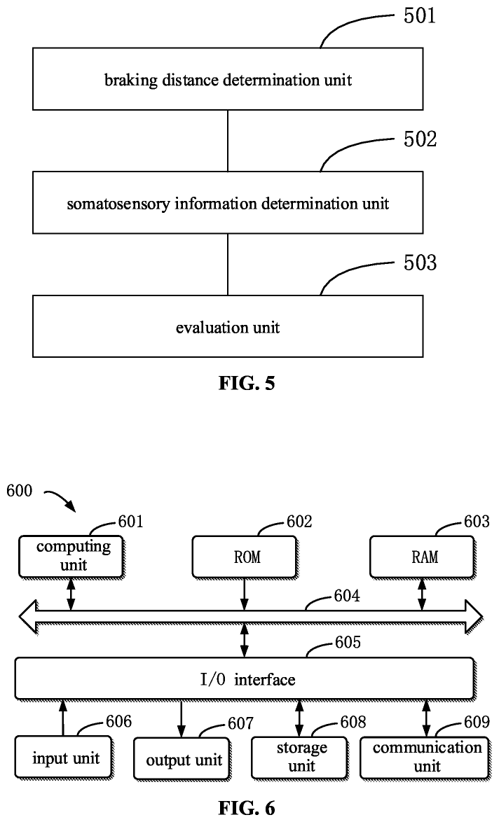

In one implementation, as shown in FIG. 5, the evaluation module 403 includes:

a braking distance determination unit 501, configured for determining a braking distance in the current braking process according to the collected position data;

a somatosensory information determination unit 502, configured for determining somatosensory information of the current braking process according to the collected vehicle speed data, acceleration data and jerk data; and

an evaluation unit 503, configured for evaluating the braking effect according to the braking distance and the somatosensory information.

In one implementation, the first braking parameter includes a braking traction absolute value, a braking traction speed and a braking traction acceleration.

In one implementation, the braking apparatus of the embodiment of the present disclosure may further include:

a second braking control signal generation module, configured for generating, in a case where the braking trigger signal is received, a second braking control signal according to a second braking parameter of the vehicle, wherein the second braking control signal is used to control a clutch traction mechanism to draw a clutch pedal according to the second braking parameter, so as to separate an engine of the vehicle from a gearbox of the vehicle.

In one implementation, the second braking parameter includes a clutch traction absolute value, a clutch traction speed and a clutch traction acceleration.

The functions of respective modules in respective apparatuses of the embodiments of the present disclosure may refer to corresponding descriptions of the above method, and will not be described in detail herein.

According to embodiments of the present disclosure, the present disclosure also provides an electronic device, a readable storage medium and a computer program product.

The technical solutions of embodiments of the present disclosure can be applied to an intelligent training vehicle, and can automatically calibrate braking parameters of the vehicle, thereby optimizing the braking effect and improving the user's somatic sensation.

FIG. 6 shows a schematic block diagram of an example electronic device 600 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 6, the electronic device 600 includes a computing unit 601 that may perform various suitable actions and processes according to computer programs stored in a read only memory (ROM) 602 or computer programs loaded from a storage unit 608 into a random access memory (RAM) 603. In the RAM 603, various programs and data required for the operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the electronic device 600 to exchange information/data with other devices over a computer network, such as the Internet, and/or various telecommunications networks.

The computing unit 601 may be various general purpose and/or special purpose processing assemblies having processing and computing capabilities. Some examples of the computing unit 601 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 601 performs various methods and processes described above. For example, in some embodiments, the braking method may be implemented as computer software programs that are physically contained in a machine-readable medium, such as the storage unit 608. In some embodiments, some or all of the computer programs may be loaded into and/or installed on the electronic device 600 via the ROM 602 and/or the communication unit 609. In a case where the computer programs are loaded into the RAM 603 and executed by the computing unit 601, one or more of steps of the above braking method may be performed. Alternatively, in other embodiments, the computing unit 601 may be configured to perform the above braking method in any other suitable manner (e.g., by means of a firmware).

Various implementations of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described herein may be implemented on a computer having: a display device (e.g., a cathode ray tube (CRT) or a liquid crystal display (LCD) monitor) for displaying information to the user; and a keyboard and a pointing device (e.g., a mouse or a trackball), through which the user can provide an input to the computer. Other kinds of devices can also be used to provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with implementations of the systems and techniques described herein) that may include a front-end component, or a computing system that may include any combination of such background components, middleware components, or front-end components. The components of the system may be connected to each other through a digital data communication in any form or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other. The server may be a cloud server, may also be a server of a distributed system, or a server incorporating a blockchain.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. A braking method for a vehicle, comprising:
generating, in a case where a braking trigger signal is received, a first braking control signal according to a first braking parameter of the vehicle, wherein the first braking control signal is used to control a braking traction mechanism to draw a brake pedal according to the first braking parameter, to perform braking;
collecting braking data of a current braking process;
evaluating a braking effect of the current braking process according to the collected braking data; and
determining whether to adjust the first braking parameter according to a result of the evaluating, wherein the determined first braking parameter is used for a next braking process of the vehicle.

2. The braking method of claim 1, wherein the collecting the braking data of the current braking process comprises:
collecting at least one of position data, vehicle speed data, acceleration data or jerk data of the vehicle in the current braking process.

3. The braking method of claim 2, wherein the evaluating the braking effect of the current braking process according to the collected braking data comprises:
determining a braking distance in the current braking process according to the collected position data;
determining somatosensory information of the current braking process according to the collected vehicle speed data, acceleration data and jerk data; and
evaluating the braking effect according to the braking distance and the somatosensory information.

4. The braking method of claim 1, wherein the first braking parameter comprises a braking traction absolute value, a braking traction speed and a braking traction acceleration.

5. The braking method of claim 1, further comprising:
generating, in a case where the braking trigger signal is received, a second braking control signal according to a second braking parameter of the vehicle, wherein the second braking control signal is used to control a clutch traction mechanism to draw a clutch pedal according to the second braking parameter, to separate an engine of the vehicle from a gearbox of the vehicle.

6. The braking method of claim 5, wherein the second braking parameter comprises a clutch traction absolute value, a clutch traction speed and a clutch traction acceleration.

7. An electronic device, comprising:
at least one processor; and
a memory communicatively connected with the at least one processor, wherein
the memory stores instructions executable by the at least one processor, and the instructions, when executed by the at least one processor, enable the at least one processor to perform operations of:
generating, in a case where a braking trigger signal is received, a first braking control signal according to a first braking parameter of the vehicle, wherein the first braking control signal is used to control a braking traction mechanism to draw a brake pedal according to the first braking parameter, to perform braking;
collecting braking data of a current braking process;
evaluating a braking effect of the current braking process according to the collected braking data; and
determining whether to adjust the first braking parameter according to a result of the evaluating, wherein the determined first braking parameter is used for a next braking process of the vehicle.

8. The electronic device of claim 7, wherein the collecting the braking data of the current braking process comprises:
collecting at least one of position data, vehicle speed data, acceleration data or jerk data of the vehicle in the current braking process.

9. The electronic device of claim 8, wherein the evaluating the braking effect of the current braking process according to the collected braking data comprises:
determining a braking distance in the current braking process according to the collected position data;
determining somatosensory information of the current braking process according to the collected vehicle speed data, acceleration data and jerk data; and
evaluating the braking effect according to the braking distance and the somatosensory information.

10. The electronic device of claim 7, wherein the first braking parameter comprises a braking traction absolute value, a braking traction speed and a braking traction acceleration.

11. The electronic device of claim 7, wherein the instructions, when executed by the at least one processor, enable the at least one processor to further perform an operation of:
generating, in a case where the braking trigger signal is received, a second braking control signal according to a second braking parameter of the vehicle, wherein the second braking control signal is used to control a clutch traction mechanism to draw a clutch pedal according to the second braking parameter, to separate an engine of the vehicle from a gearbox of the vehicle.

12. The electronic device of claim 11, wherein the second braking parameter comprises a clutch traction absolute value, a clutch traction speed and a clutch traction acceleration.

13. A non-transitory computer readable storage medium storing computer instructions, wherein the computer instructions, when executed by a computer, cause the computer to perform operations of:
generating, in a case where a braking trigger signal is received, a first braking control signal according to a first braking parameter of the vehicle, wherein the first braking control signal is used to control a braking traction mechanism to draw a brake pedal according to the first braking parameter, to perform braking;
collecting braking data of a current braking process;
evaluating a braking effect of the current braking process according to the collected braking data; and
determining whether to adjust the first braking parameter according to a result of the evaluating, wherein the determined first braking parameter is used for a next braking process of the vehicle.

14. The non-transitory computer readable storage medium of claim 13, wherein the collecting the braking data of the current braking process comprises:
collecting at least one of position data, vehicle speed data, acceleration data or jerk data of the vehicle in the current braking process.

15. The non-transitory computer readable storage medium of claim 14, wherein the evaluating the braking effect of the current braking process according to the collected braking data comprises:
determining a braking distance in the current braking process according to the collected position data;
determining somatosensory information of the current braking process according to the collected vehicle speed data, acceleration data and jerk data; and
evaluating the braking effect according to the braking distance and the somatosensory information.

16. The non-transitory computer readable storage medium of claim 13, wherein the first braking parameter comprises a braking traction absolute value, a braking traction speed and a braking traction acceleration.

17. The non-transitory computer readable storage medium of claim 13, wherein the computer instructions, when executed by the computer, cause the computer to further perform an operation of:
generating, in a case where the braking trigger signal is received, a second braking control signal according to a second braking parameter of the vehicle, wherein the second braking control signal is used to control a clutch traction mechanism to draw a clutch pedal according to the second braking parameter, to separate an engine of the vehicle from a gearbox of the vehicle.

18. The non-transitory computer readable storage medium of claim 17, wherein the second braking parameter comprises a clutch traction absolute value, a clutch traction speed and a clutch traction acceleration.

19. A vehicle comprising an electronic device, wherein the electronic device comprises:
at least one processor; and
a memory communicatively connected with the at least one processor, wherein
the memory stores instructions executable by the at least one processor, and the instructions, when executed by the at least one processor, enable the at least one processor to perform operations of:
generating, in a case where a braking trigger signal is received, a first braking control signal according to a first braking parameter of the vehicle, wherein the first braking control signal is used to control a braking traction mechanism to draw a brake pedal according to the first braking parameter, to perform braking;
collecting braking data of a current braking process;
evaluating a braking effect of the current braking process according to the collected braking data; and
determining whether to adjust the first braking parameter according to a result of the evaluating, wherein the determined first braking parameter is used for a next braking process of the vehicle.

20. The vehicle of claim 19, wherein the collecting the braking data of the current braking process comprises:
collecting at least one of position data, vehicle speed data, acceleration data or jerk data of the vehicle in the current braking process.
